(19) United States
(12) Patent Application Publication
(10) Pub. No.: US 2015/0082333 A1
(43) Pub. Date: Mar. 19, 2015

(54) Event Enhancement via Viewer Participation

(71) Applicant: Thomas Belton, Pipersville, PA (US)

(72) Inventor: Thomas Belton, Pipersville, PA (US)

(21) Appl. No.: 14/488,325

(22) Filed: Sep. 17, 2014

Related U.S. Application Data
(60) Provisional application No. 61/879,011, filed on Sep. 17, 2013.

(51) Int. Cl. H04N 21/475; H04N 21/81; H04N 7/173; H04H 60/33

(52) U.S. Cl. CPC H04N 21/4755; H04H 60/33; H04N 21/8126; H04N 7/173; H04N 21/4758
USPC 725/24

(57) ABSTRACT

A system for fans to influence the action of a sporting event in real-time is disclosed. Remotely located viewers of a live broadcast of a sporting event not only follow the progress of the event, but may actually influence it. When the event reaches an option situation, requiring execution of strategic action, the remote viewing fan may select the option they think most appropriate from a list of options and transmit their choice to a central location. A most favored option may be selected and relayed to the appropriate players or officials. The players may then execute the most favored option as an actual play in the game being broadcast.

### CLAIM OF PRIORITY

This application claims priority to U.S. Ser. No. 61/879011 filed on Sep. 17, 2014, the contents of which are fully incorporated herein by reference.

### FIELD OF THE INVENTION

The invention relates to a system and method of enabling viewers to interact with a sporting event, and more particular to a system and method that allows viewers to compete with each other on predicting game calls and results and to make calls that actually occur in the game.

### BACKGROUND OF THE INVENTION

Many sporting events have become extremely popular as spectator events on broadcast television, while certain events are also, or instead, being broadcast over alternative interactive media such as the internet in the form of updated statistics, as well as over older media such as radio.

In both the traditional televised broadcasts and the broadcasts over the newer interactive media, the viewers are essentially passive watchers of a game, with no capability to influence the course, or outcome, of the event.

Many younger people have become accustomed to playing realistic video games in which they are actively engaged in both the course and the outcome of an event, and do not find passive viewing of sports events as particularly entertaining.

In order to compete for the attention of these younger viewers, who expect active involvement throughout the course of the entertainment, there is a need for new ways of broadcasting sporting events so that they are made appealing by providing viewer participation in the outcome of the event.

### SUMMARY OF THE INVENTION

An inventive system and method that may enable fans to influence the action of a sporting event in real-time is disclosed.

In a preferred embodiment when a sporting event being played at a location is broadcast on a suitable medium such as, but not limited to, a cable television network, an Internet network, a terrestrial television of radio broadcast, or some combination thereof, viewers situated remote from the location may follow the progress of the event. When the event reaches an option situation, i.e., an instance in which a coach or team captain may normally opt to execute one or more actions that may have been preplanned and rehearsed, the remote viewer who is a fan of the team or person about to select and execute the option, may be presented with a list of possible options. The fan may select the option they think most appropriate and may transmit their choice to a central location, or aggregator. Once the coach or captain selected option is executed, the aggregator may award points to fans who either made the correct choice, or came closest to that choice.

In a further preferred option, the aggregator may determine a most preferred option selected by the fans, and that option may then be conveyed to the coach or captain who may then execute the option selected by the fans.

Therefore, the present invention succeeds in conferring the following, and others not mentioned, desirable and useful benefits and objectives.

It is an object of the present invention to provide a means for fans to compete against each other while watching a live broadcast of a sporting event.

It is another object of the present invention to provide fans the opportunity to influence the sporting event they are watching live.

### BRIEF DESCRIPTION OF THE DRAWINGS

FIG. 1 shows a schematic view of a method of fans influencing the action of a sporting event in real-time.

FIG. 2 shows schematic flow diagram of a method of fans competing with each other during a live sporting event.

FIG. 3 shows a schematic flow diagram of a method of fans influencing the action of a sporting event in real-time.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

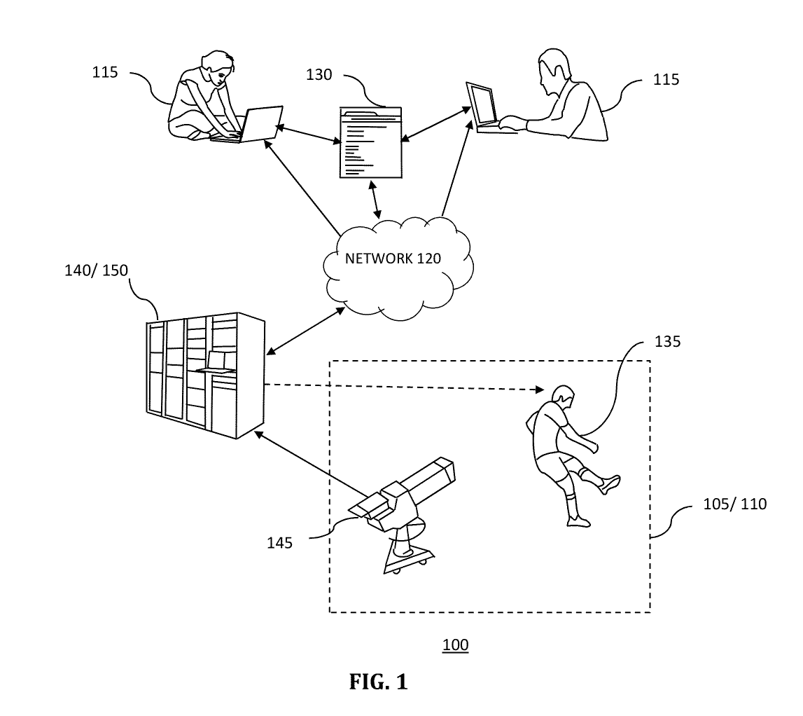

FIG. 1 shows a schematic view of a method of fans influencing the action of a sporting event in real-time 100. A sporting event 105 may be being played, or contested, by one or more players 135 in a location 110 that may, for instance, be a stadium or field. The sporting event 105 may be being televised using one or more broadcast camera 145, and being broadcast via a broadcast medium 120 to one or more fans 115. The broadcast medium 120 may be a network such as, but not limited to, a cable television network, a broadband digital network, a terrestrial or satellite television broadcast network, a radio network or some combination thereof. The broadcast may be edited using a digital signal processing unit 150.

In a preferred embodiment of the present invention, a plurality of fans 115, situated remotely from the stadium or location 105, and remotely from each other, may follow the progress of the sporting event. When the progress of said sporting event reaches an option situation 125 requiring a selection of one of a plurality of options 130 by one or more players 135 participating in said sporting event, each of said plurality of fans may select the option they think will be chosen by the players of the actual game. The fans' choices may then be sent or relayed to a common aggregator 140. Such an option situation 125 may for instance be an event such as, but not limited to, a football snap where a coach or quarterback may call a particular play, or a baseball game in which a pitcher or catcher may call for a particular pitch to be thrown, a tennis match in which the serving play may decide on a particular service to make.

The fans may simply compete with each other in a game to test who has a better coaching knowledge of the game, or they might actually influence the option executed in the game.

When simply played as a game or contest between competing fans, the fans may sent a plurality of options 130 when an option situation 125 occurs in the game. They fans may then have until the actual option in the game being played in the stadium is made, to submit their selection of what the option will be. The fans may then score points for selecting the correct option, or the option deemed closest to the actually executed option. The points awarded may be adjusted for factors such as, but not limited to, the criticality of the option situation 125, how quickly the fan selected the option, the probability of such an option being selected in such a situation, or some combination thereof. More points may, for instance, be awarded to the first fan to select the winning option, or to correctly selecting an option that is rarely used in such a situation.

In an embodiment in which the fans' selection may actually influence the play, the fans may be supplied with a plurality of options 130 when an option situation 125 occurs. This plurality of options 130 may be presented to the fan in a form such as, but not limited to, graphics displayed on a TV or video screen, a list of option read out by an announcer, a preloaded list of options, a list on an app or some combination thereof. The fans 115 may then make a selection that may be sent back to an aggregator 140 that may, for instance, be a software module operation on the digital signal processing unit 150. The selection may be made as a message such as, but not limited to, a text message, a response via an Internet connection, a button selection on a telephone call, or some combination thereof.

The aggregator 140 may then determine a most favored option that may, for instance, be the option selected by the largest number of fans or the option selected by the n^{th} responder, where n is preselected integer.

The aggregator may then transmit the most favored selected option to one or more of the participating players who may then execute the most favored selected option. This transmission may, for instance, be via a radio link to the helmet of a player who is usually responsible for making the selection, or it may be transmitted wirelessly to a coach who usually make the call who may then use their standard method of making the call such as, but not limited to, instructing a participating player on the sidelines who then rejoins the game and relays the selection to his teammates.

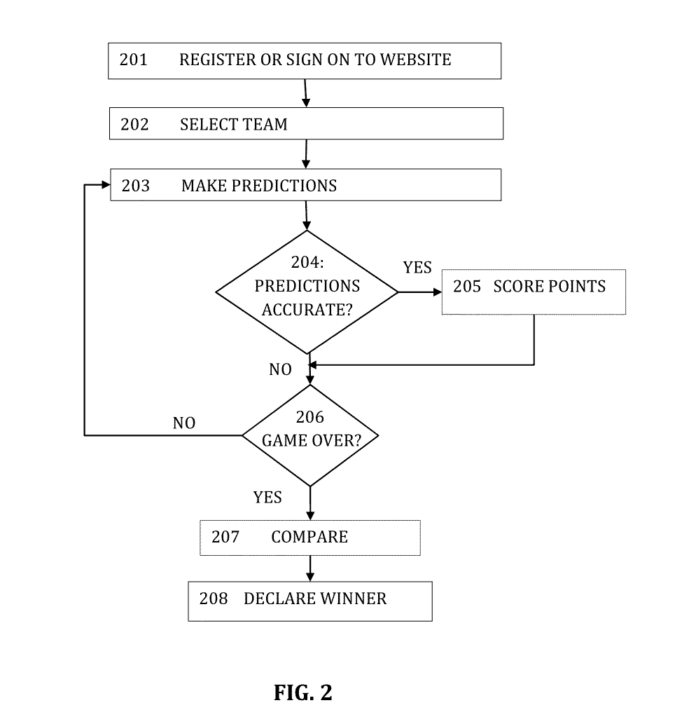

FIG. 2 shows schematic flow diagram of a method of fans competing with each other during a live sporting event.

In a preferred embodiment of this version of the present invention, a first step may be Step 201: Register or sign on to website. The website may, for instance, be operable on webserver that may be operable on the digital signal processing unit 150 and may also serve as an aggregator of responses. Registration may include downloading an app for a smartphone. Such an app may for instance be able to be synchronized with a live event so that the fan may use a smartphone to receive lists of possible options available when an option situation in the game is reached. The smartphone app may also be used to send back the fan's choice or prediction to the central aggregator.

Step 202: Select team. In this step a participating fan may select which team, side or player they are a supporter of, and whose selections they want to predict.

Step 203: Make predictions. In this step, the game may have reached an option situation 125, i.e., a point in the game in which a strategic decision needs to be made and then implemented or executed. The fan may be supplied with a list of options that are possible, or likely, in such an option situation. The fan may then select one of the options prior to the option being implemented in the actual game. This selection may then be relayed to an aggregator that may be collecting all responses of participating fans, or only the responses of fans of a particular match or game, or only fans of one team or participant of a particular match or game.

Step 204: Predictions accurate? The aggregator may compare responses with the actual option that was executed. If the prediction is accurate, or nearly accurate, the aggregator may then move to Step 205: Score points. Points may be awarded for accuracy. They may also be awarded or augmented for factors such as, but not limited to, the promptness of the response, the criticality of the option situation, the probability of such an option typically being executed in such a option situation 125 or some combination thereof.

In Step 206, the aggregator may determine if the game has been completed, or a segment of the game has been completed.

If the game is determined to be complete, then the aggregator may move to Step 207 and compare the scores of all the fans, and then in Step 208 declare a winner.

In variants of the game, comparisons may be made after a segment of the game is complete. For instance, in a football game a comparison may be made after each quarter.

The winner may also be determined by weighting or handicapping fans. For instance, a winner of a previous contest may start with a point or percentage handicap that may lower the points they receive for making a correct prediction so that the contest may be more competitive. Other winners may be the most improved fan compared with a previous match or game involving the team.

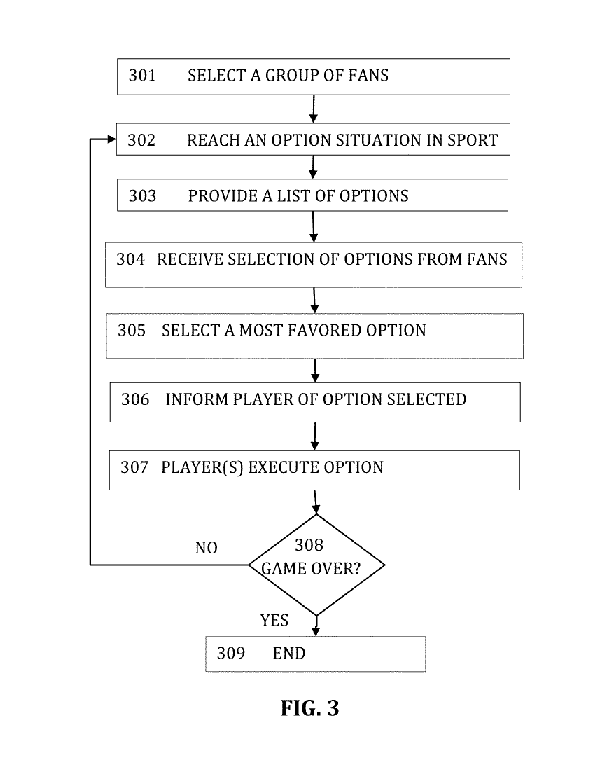

FIG. 3 shows a schematic flow diagram of a method of fans influencing the action of a sporting event in real-time.

Step 301: Select a group of fans. This may simply be all the fans who sign on as fans of a particular team. However, as this group may be going to influence one or more situations in an actual game, the selection criteria may be more stringent. For instance, group of fans whose selection may actually influence an actual play in the game may be limited to a group of eligible fans such as, but not limited to, a group of the winners of a game with that team throughout the season, the top 5 or 10 percent of game winning fans in a previous match, a group selected by lottery, the upper 5^{th} percentile of fans in a previous game, fans willing to donate an amount of money to a charity, or some combination thereof.

Step 302: Reach an option situation in a sport. For fans selecting an option that will actually be executed, the criteria for what constitutes an option situation may be more stringent. The executable option situations may, for instance, be limited to options situations such as, but not limited to, a decision after a coin toss, the first play in a game, the first play in every quarter of the game, the nth play in the game, the nth play in a quarter, a play situation such as third down plays, or third down plays with a minimum or maximum amount of ground to be gained, a randomly selected play in a game or a quarter, or some combination thereof.

Step 303: Provide a list of options. This may be a list provided to eligible fans such as, but not limited to, a list of a teams known plays, or plays that they have previously used in equivalent or similar situations, of all plays possible in equivalent of similar situations, or some combination thereof. The list may include further information such as, but not limited to, the percentage use of a given option by the team in the past when they were in an equivalent of similar situation.

Step 304: Receive selection of options from eligible fans. Eligible fans may have a limited time in which to submit their selection of an option.

Step 305: Select a most favored option. The most favored option may simply be the option selected by the largest number of eligible fans. Alternately, each favored fan may be weighted according to their prior performance and the most favored option may factor in these weightings. The weighting may be linear function dependent on their performance rank. For instance, if there are 100 eligible fans, the best performing eligible fan may have a weighting of 1, whereas the 100 th best performing eligible fan, i.e. the worst performing fan of the group, may have a weighting of 0.5, and all the eligible fans in between may have a rating given by drawing a straight line between the weightings of the best and the worst eligible fans on a graph where one axis is the rank, and the other is the weighting. Alternately, the weighting may be Zipf type weighting in which the weighting of the nth ranking eligible fan is 1/n.

Step 306: Inform player of option selected. This may for instance be accomplished by the aggregator, or an aggregator operator, contacting one or more of the players on the field via a wireless connection to headphones in their helmet. Alternately, the aggregator, or aggregator operator, may contact a coach or other official who typically then contacts the appropriate players via their usual method of communication.

Step 307: Players execute option. The players may then execute the most favored option. The most favored option may be relayed to, or broadcast to, the entire viewing audience, or merely the team fans, or merely the eligible fans participating in the selection, prior to the action occurring to further enhance their sense of having been involved in the play.

In further embodiments of the invention, fans may also or instead make quantitative predictions on sports team & player performances and individual plays during the course of a game and the season. These predictions may be made on a specific team or player in an individual sport. Each participant may receive a performance rating—Coaching EQ—based on the accuracy of his or her predictions—overall and by category.

Accuracy may, for instance, be quantized as a binary yes/no or may be related to a simple difference between a predicted score, distance, no. of attempts, completions compared to the actual predicted score, distance, no. of attempts, completions, or it may be a derivative of that difference such as, but not limited to, a square root of the distance, or some other mathematical equation so as to more fully reward an accuracy of prediction. The accuracy may, for instance, be rated as 100—(diff) or 100—diffⁿ, where n may be any suitable number, and diff represents a difference between the prediction and actual performance. This diff may be expressed as a percentage or a number.

In contrast to fantasy sports leagues where users focus solely on individual performances with no loyalty to or vested interest in a real team, the method and system of the present invention aligns the participant to the performance of the selected team—presumably his or her favorite team—and thus there is no conflict in having to root for a player who can hurt your favorite team. Fans in current fantasy sports leagues act once during the season as a general manager and draft players. Fans in the system and method of this invention are coaches and strategists every season, every game, every play.

In a preferred embodiment there may be 3 parts to the game. First, there is the pre-game play. The fan may make predictions of the team and key player performance during the upcoming game or match broken down into categories of individual and team performance. Examples of team categories include, but not limited to: Win or loss; Points for and against; Offensive output categories (e. g. home runs and OBP in baseball, rushing & passing yards in football); Defensive categories (e.g. yards allowed & sacks in football and team ERA and opponents' batting average in baseball).

The fan may also select key players and makes similar predictions of offensive and defensive output on the individual level. Points may be awarded to the fan based on the degree of accuracy in the predictions compared to actual result if the deviation is less than 25%. For example, if a football fan accurately predicted the winner and final score, 100 points may be awarded for guessing the winner and a maximum of 100 points for predicting the score. If the score prediction was off by more than 25%, he may only get 100 points for picking the winner. If the scoring prediction was less than 25% off, points on a sliding scale of 1-100 may be awarded depending on how close the prediction was. The same, or similar, point system may works on the key performance indicators for individual and team levels.

The following are examples of team and individual categories. Baseball: Team categories (by game and for the season): Team ERA: Team strikeouts; Team batting average; Team OBP: Home runs, doubles, trips; Slugging percentage. Player categories (by game and for the season): Batting average; HR's, doubles, triples; OBP; Slugging %; ERA; Win v Loss; Strikeouts; Walks; Errors.

Football: Team categories (by game and for the season): game score; Points for and against; yards offense & defense; passing yards; rushing yards; # passing plays & running plays; Sacks; TNT's.

Individual categories (by game and for the season): QB rating; Rushing yards; receiving yards; Tackles; Sacks

The second part of the game play may involve making predictions of play calls during the game or match immediately prior to the actual play, as described in more detail above.

The 3rd part of the game may involve the highest scoring fans from the first 2 parts of the game play during the season selected as winners/finalists to make real calls in a live game in a similar manner to that described above. This may, for instance, use a majority vote of fans selecting a play from their online device or mobile app, the play chosen by the fans is used in the live action by the real players. The vote may be weighted by the ranking of the fan making the play, so that, for instance, the highest ranking fan may receive 2 votes, while the lowest ranking only receives 1 vote. In a preferred embodiment, the real games for this phase may be games that do not impact regular or post season standings of the team, such as the NFL Pro Bowl, the NBA and MLB All-Star games, pre-season games, Ryder Cup or President's Cup for golf, and charity or celebrity matches. An example of this interactivity in a team golf match is described in detail in a related patent—System and Method for a Golf Tournament (U.S. Pat. No. 8,133,124 B2, issued Mar. 13, 2012).

One of ordinary skill in the art will further appreciate that the system and method of the present invention may be easily adapted to a large number of sports, including, but not limited to, football, baseball, basketball, hockey, golf, tennis, soccer, car racing, and virtually every other team sport where coaching strategy is involved.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A method of fans influencing the action of a sporting event in real-time, comprising:
A sporting event being played at a location;
A plurality of fans situated remotely from said location, and remotely from each other, following the progress of said sporting event via a broadcast medium; and, when the progress of said sporting event reaches an option situation requiring a selection of one of a plurality of options by one or more players participating in said sporting event, each of said plurality of fans selecting an option and relaying said selected option to an aggregator;
said aggregator determining a most favored selected option and relaying said most favored selected option to one or more of said participating players; and
said one or more participating players executing said most favored selected option.

2. The method of claim 1 further comprising displaying said selected option to a TV audience prior to said option being executed by said one or more participating players.

3. The method of claim 1 wherein said plurality of fans are selected from a group of fan participants having previously participated in said selection event.

4. The method of claim 3 wherein said selected plurality of fans comprise fans having been in a top fifth percentile of fans who successfully predicted the option that was executed in a least one prior option situation.

5. The method of claim 1 wherein said plurality of fans are selected from a group of fan participants having pledged a contribution of value to an organization associated with said broadcast of said sporting event.

6. A method of fans anticipating the action of a sporting event in real-time, comprising:
a sporting event being played at a location;
a plurality of fans, situated remotely from said location, and remotely from each other, following the progress of said sporting event via a broadcast medium;
when the progress of said sporting event reaches an option situation requiring a selection of one of a plurality of options by one or more players participating in said sporting event, each of said plurality of fans selecting an option and relaying said selected option to an aggregator; and
on execution of said option, said aggregator rewarding one or more of said fans, said reward reflecting a match between said option selected by said fan and an option executed by said one or more players.

7. The method of claim 6 further comprising announcing or displaying on said broadcast medium, a percentage of said plurality of option selecting fans that selected the executed option.

8. The method of claim 6 wherein said reward comprises said fan participating in a selection of an option, in which a most favored selected option is relayed to one or more of said participating players; and said one or more participating players execute said most favored selected option.
